(19) United States
(12) Patent Application Publication
(10) Pub. No.: US 2006/0117206 A1
(43) Pub. Date: Jun. 1, 2006

(54) Method and apparatus for enhancing work efficiency by sharing application between host and hard disk drive

(75) Inventors: Serguei Boldyrev, Suwon-si (KR); Jun-seok Shim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/257,105

(22) Filed: Oct. 25, 2005

(30) Foreign Application Priority Data
Nov. 16, 2004 (KR) 10-2004-0093572

(51) Int. Cl. G06F 11/00

(52) U.S. Cl. 714/2

(57) ABSTRACT

A method and apparatus for enhancing work efficiency by sharing an application between a host and a hard disk drive are provided. The method includes: forming an application interface allowing the host and the hard disk drive to share an application included in the host or hard disk drive with each other; transmitting a first control code of a first application included in the host from the host to the hard disk drive through the formed application interface; and the hard disk drive controlling a process of the first application using the transmitted first control code. Accordingly, since the application is shared between the host and the hard disk drive, the workload of the host can be shared with the hard disk drive, or the workload of the hard disk drive can be shared with the host.

### BACKGROUND OF THE INVENTION

This application claims priority from Korean Patent Application No. 10-2004-0093572, filed on Nov. 16, 2004, in the Korean Intellectual Property Office, the entire disclosure of which is incorporated herein by reference.

1. Field of the Invention

Apparatuses and methods consistent with the present invention relate to an interface between a host and a hard disk drive, and more particularly, to enhancing work efficiency by sharing an application between a host and a hard disk drive.

2. Description of the Related Art

A hard disk drive is a secondary storage device that has an aluminum platter coated with a magnetic medium to store data thereon. Due to recent increases in packing density and reduction of the physical size of a hard disk drive, an interface delay between a host and the hard disk drive occurs which results in reduced work efficiency between the host and the hard disk drive. To solve these problems, an integrated circuit may be used only for the hard disk drive, but such an approach provides only limited improvement in the interface delay and work efficiency between the host and the hard disk drive.

### SUMMARY OF THE INVENTION

The present invention provides a method of enhancing work efficiency by sharing an application between a host and a hard disk drive.

The present invention also provides an apparatus for enhancing work efficiency by sharing an application between a host and a hard disk drive.

According to an aspect of the present invention, there is provided a method of enhancing work efficiency by sharing an application between a host and a hard disk drive, the method comprising: forming an application interface between the host and the hard disk drive to share an application included in the host or hard disk drive with each other; transmitting a first control code of a first application included in the host from the host to the hard disk drive through the formed application interface; and the hard disk drive controlling a process of the first application with the transmitted first control code.

According to another aspect of the present invention, there is provided an apparatus for enhancing work efficiency by sharing an application between a host and a hard disk drive, the apparatus comprising: an application interface unit which forms an application interface to allow the host and the hard disk drive to share an application included in the host or hard disk drive; a first control code storage medium receiving a first control code of a first application included in the host from the host through the formed application interface and storing the first control code; and a first process controlling unit of the hard disk drive controlling a process of the first application with the stored first control code.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a method of enhancing work efficiency by sharing an application between a host and a hard disk drive according to an exemplary embodiment of the present invention; and

FIG. 2 is a block diagram of an apparatus for enhancing work efficiency by sharing an application between a host and a hard disk drive according to an exemplary embodiment of the present invention.

### DETAILED DESCRIPTION OF THE EXEMPLARY EMBODIMENTS

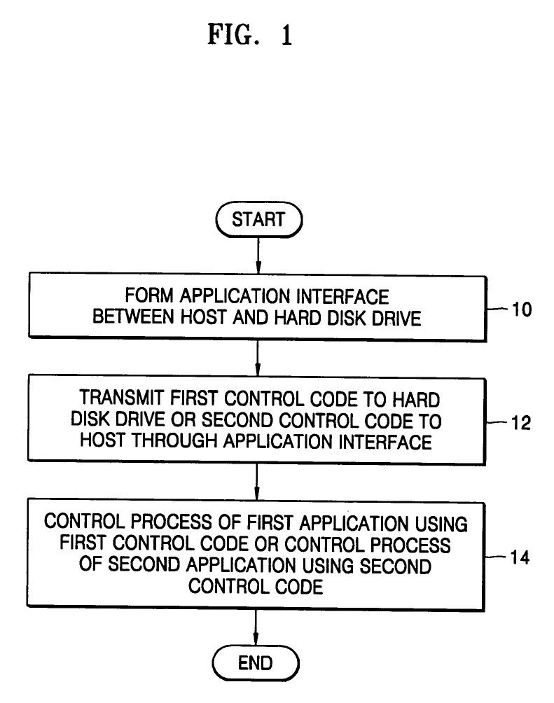

FIG. 1 is a flowchart illustrating a method of enhancing work efficiency by sharing an application between a host and a hard disk drive according to an exemplary embodiment of the present invention.

First, an application interface is formed to allow the host and the hard disk drive to share an application included in the host or the hard disk drive (operation 10).

Several types of applications such as a text editing application, a data searching application, a media player application, an MPEG Audio Layer 3 (MP3) player application, and the like are included in the host or the hard disk drive.

An interface allowing a host and a hard disk drive to share an application therebetween is referred to as an application interface. A network for sharing the application between the host and the hard disk drive can be formed by the application interface between the host and the hard disk drive.

Specifically, an open vendor command application program interface (OVC API) is set in the hard disk drive as the application interface. The OVC API is an interface for an application command which is uniquely defined by a manufacturer to allow sharing of the application between a host and a hard disk drive.

After operation 10, a first control code of a first application included in the host is transmitted to the hard disk drive through the application interface formed between the host and the hard disk drive (operation 12).

For example, one or more applications, among a text editing application, a data searching application, a media player application, and an MP3 player, which are included in the host, may be referred to as a first application. Further, a first control code is a command language which controls the first application. The first control code is an application object code. The application object code is a machine language code generated for a hard disk drive to control an application.

The first control codes included in the host can be grouped as a bundle and transmitted to the hard disk drive.

Meanwhile, in operation 12, a second control code of a second application included in the hard disk drive may be transmitted to the host through the application interface. For example, an application, such as a text editing application, a data searching application, etc., which is stored in a hard disk drive, may be referred to as a second application. Thus, the second control code is a command language which controls the second application. The second control code is an application object code similar to the first control code.

After operation 12, the hard disk drive controls a process of the first application by using the transmitted first control code (operation 14). In particular, the hard disk drive controls one of power managing, information searching, and data storing, which are processes of the first application, using the transmitted first control code. For instance, when receiving a first control code for the text editing application included in the host, the hard disk drive performs a control of the text editing application using the received first control code. Further, when receiving a first control code for the power managing application included in the host, the hard disk drive performs a control of the power managing application by using the received first control code. In addition, when receiving a first control code for the information searching application included in the host, the hard disk drive performs a control of the information searching application by using the received first control code. Also, when receiving a first control code for the data storing application included in the host, the hard disk drive performs a control of the data storing application by using the received first control code.

In the meantime, in operation 14, the host may control a process of the second application by using the second control code which is transmitted to the host. In particular, the host controls one of information searching and data storing, which are processes of the second application, using the transmitted second control code. For example, when receiving a second control code for the information searching application stored in the hard disk drive, the host performs a control of the information searching application by using the received second control code. Further, when receiving a second control code for the data storing application stored in the hard disk drive, the host performs a control of the data storing application by using the received control code.

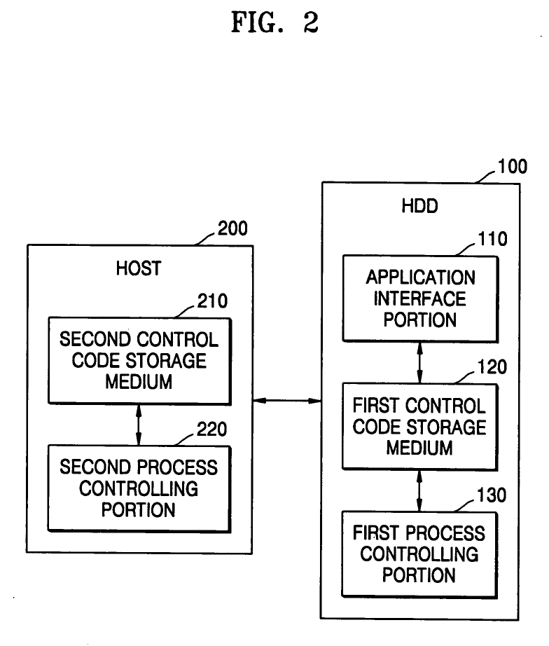

FIG. 2 is a block diagram of an apparatus for enhancing work efficiency by sharing an application between a host 200 and a hard disk drive (HDD) 100. The apparatus includes the hard disk drive 100 and the host 200. The hard disk drive 100 includes an application interface unit 110, a first control code storage medium 120, and a first process controlling unit 130. The host 200 includes a second control code storage medium 210 and a second process controlling unit 220.

The hard disk drive 100 is a machine device which controls storage and retrieval of data from the hard disk storage medium.

The application interface unit 110 forms an application interface which allows an application included in the host 200 or hard disk drive 100 to be shared between the host 200 and the hard disk drive 100.

The application interface unit 110 sets an open vendor command application program interface (OVC API) as an application interface so that an application program interface is formed between the host 200 and the hard disk drive 100.

The first control code storage medium 120 receives a first control code of a first application which is included in the host 200 from the host 200 through the application interface formed by the application interface unit 110 and stores the first control code. The first control code storage medium 120 stores an application object code as the first control code.

The first control code storage medium 120 stores a plurality of first control codes which are grouped as a bundle and transmitted from the host 200.

The first process controlling unit 130 controls a process of a first application of the host 200 using the first control code stored in the first control code storage medium 120. In particular, the first process controlling unit 130 controls one of text editing, power managing, information searching and data storing, which are processes of the first application, using the transmitted first control code.

The host 200 may be a general local computer, or a computer connected to a network.

The second control code storage medium 210 included in the host 200 receives the second control code of the second application included in the hard disk drive 100 from the hard disk drive 100 through the application interface formed by the application interface unit 110 and stores the second control code. In particular, the second control code storage medium 210 stores an application object code as the second control code.

The second process controlling unit 220 included in the host 200 controls a process of the second application by using the second control code which is stored in the second control code storage medium 210. Specifically, the second process controlling unit 220 controls one of information searching and data storing, which are processes of the second application, by using the transmitted second control code.

As described above, according to aspects of the present invention, a method and apparatus for enhancing work efficiency by sharing an application between a host and a hard disk drive allows the hard disk drive to share the workload of the host, or the host to share the workload of the hard disk drive.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of enhancing work efficiency by sharing an application between a host and a hard disk drive, the method comprising:
forming an application interface between the host and the hard disk drive to share an application which is included in the host or the hard disk drive with each other;
transmitting a first control code of a first application which is included in the host from the host to the hard disk drive through the application interface which is formed; and
controlling, by the hard disk, a process of the first application using the first control code which is transmitted.

2. The method of claim 1, wherein the forming of the application interface sets an open vendor command application program interface as the application interface in the hard disk drive.

3. The method of claim 1, wherein the first control code is an application object code.

4. The method of claim 3, wherein in the transmitting of the first control code, a plurality of first control codes which are included in the host are grouped as a bundle and transmitted to the hard disk drive.

5. The method of claim 1, wherein the hard disk drive controls the process of the first application using the first control code which is transmitted and the process is one of power managing, text editing, information searching and data storing.

6. The method of claim 1, further comprising:
transmitting a second control code of a second application which is included in the hard disk drive from the hard disk drive to the host through the application interface which is formed; and
controlling, at the host, a process of the second application using the second control code which is transmitted.

7. The method of claim 6, wherein the second control code is another application object code.

8. The method of claim 6, wherein the host controls the process of the second application using the second control code which is transmitted and the process is one of information searching and data storing.

9. An apparatus for enhancing work efficiency by sharing an application between a host and a hard disk drive, the apparatus comprising:
an application interface unit which forms an application interface between the host and the hard disk drive which share an application which is included in the host or the hard disk drive;
a first control code storage medium which receives a first control code of a first application which is included in the host from the host through the application interface which is formed and stores the first control code; and
a first process controlling unit of the hard disk drive which controls a process of the first application using the first control code which is stored.

10. The apparatus of claim 9, wherein the application interface unit sets an open vendor command application program interface as the application interface.

11. The apparatus of claim 9, wherein the first control code storage medium stores an application object code as the first control code.

12. The apparatus of claim 11, wherein the first control code storage medium stores a plurality of first control codes which are grouped as a bundle and transmitted from the host.

13. The apparatus of claim 9, wherein the first process controlling unit controls the process of the first application using the first control code which is transmitted and the process is one of power managing, text editing, information searching and data storing.

14. The apparatus of claim 9, further comprising:
a second control code storage medium which receives a second control code of a second application, which is included in the hard disk drive, from the hard disk drive through the application interface which is formed and stores the second control code; and
a second process controlling unit which controls a process of the second application using the second control code which is stored.

15. The apparatus of claim 14, wherein the second control code storage medium stores another application object code as the second control code.

16. The apparatus of claim 14, wherein the second process controlling unit controls the process of the second application using the second control code which is transmitted and the process is one of information searching and data storing.
